(19) United States
(12) Patent Application Publication
(10) Pub. No.: US 2025/0138871 A1
(43) Pub. Date: May 1, 2025

(54) THREAD SCHEDULING METHOD AND ELECTRONIC DEVICE

(71) Applicant: Huawei Technologies Co., Ltd., Shenzhen (CN)

(72) Inventors: Bing Xie, Shenzhen (CN); Shuai Zhou, Shenzhen (CN); Ming Chen, Hangzhou (CN)

(21) Appl. No.: 19/009,511

(22) Filed: Jan. 3, 2025

Related U.S. Application Data
(63) Continuation of application No. PCT/CN2023/104311, filed on Jun. 29, 2023.

(30) Foreign Application Priority Data
Jul. 6, 2022 (CN) 202210790819.7

(51) Int. Cl. G06F 9/48; G06F 9/50

(52) U.S. Cl. CPC G06F 9/4856; G06F 9/5038; G06F 9/5088; G06F 2209/5021; G06F 2209/509

(57) ABSTRACT

An electronic device receives a first operation; detects that a first thread is in a runnable state on a first processing unit, and a second thread runs on the first processing unit; and migrates a first task of the first thread to a second processing unit, so that the first thread executes, on the second processing unit, the first task associated with the first operation, where the first task includes a layer composition task or a send-for-display task. The first thread includes a composition thread or a send-for-display thread, and a priority of the first thread is lower than a priority of the second thread.

### CROSS-REFERENCE TO RELATED APPLICATIONS

This application is a continuation of International Application No. PCT/CN2023/104311, filed on Jun. 29, 2023, which claims priority to Chinese Patent Application No. 202210790819.7, filed on Jul. 6, 2022. The disclosures of the aforementioned applications are hereby incorporated by reference in their entireties.

### TECHNICAL FIELD

This application relates to the field of terminal technologies, and in particular, to a thread scheduling method and an electronic device.

### BACKGROUND

Currently, with popularization of electronic devices such as mobile phones, users have increasingly high requirements for smoothness of applications.

As more applications are installed or more files are stored in an electronic device, freezing may occur during running of an application, and smoothness of the application is reduced, causing freezing of the application and affecting user experience. Therefore, an effective method is urgently required to improve running performance of the electronic device.

### SUMMARY

To resolve the foregoing technical problem, embodiments of this application provide a thread scheduling method and an electronic device. According to the technical solutions provided in embodiments of this application, a task of a composition thread or a send-for-display thread that affects performance of an electronic device can be dynamically migrated, to reduce a probability that a related task is blocked, and improve performance of the electronic device.

To achieve the foregoing technical objective, embodiments of this application provide the following technical solutions.

According to a first aspect, a thread scheduling method is provided, where the method is applied to an electronic device or a component that can implement a function of an electronic device, for example, a chip system. The method includes: The electronic device receives a first operation; detects that a first thread is in a runnable state on a first processing unit, and a second thread runs on the first processing unit; and migrates a first task of the first thread to a second processing unit, so that the first thread executes, on the second processing unit, the first task associated with the first operation, where the first task includes a layer composition task or a send-for-display task. The first thread includes a composition thread or a send-for-display thread, and a priority of the first thread is lower than a priority of the second thread.

In an embodiment of this application, to reduce a probability of freezing of the electronic device as much as possible, a composition thread or a send-for-display thread related to performance indicators such as smoothness and a response speed of the electronic device may be determined, and a task of the composition thread or the send-for-display thread may be dynamically migrated between different processing units. In this way, a probability that execution of the composition task or the send-for-display task is delayed can be reduced, to improve performance such as the smoothness of the electronic device.

In a possible design, that the electronic device migrates a first task of the first thread to a second processing unit includes: When detecting that duration in which the first thread is in the runnable state exceeds a threshold, the electronic device migrates the first task of the first thread to the second processing unit.

For example, the first thread is a composition thread. It may be understood that, if duration in which the composition thread is in a runnable state does not reach the threshold, it indicates that a composition task of the composition thread is not greatly affected, or performance such as the smoothness of the electronic device is not greatly affected. In this case, the task of the composition thread may be migrated after the duration in which the composition thread is in the runnable state exceeds the threshold. In this way, a probability that a task is incorrectly migrated can be reduced, and a task migration frequency can be reduced. Further, device power consumption caused thereby is reduced, and performance of the electronic device is improved.

In a possible design, a third thread runs on the second processing unit, a priority of the third thread is lower than the priority of the first thread, and that the first thread executes, on the second processing unit, the first task associated with the first operation includes: The first thread preempts the third thread and executes the first task on the second processing unit.

For example, the first thread is a composition thread. To be specific, when the composition thread cannot run on the first processing unit, the composition thread can preempt a thread with a lower priority on the second processing unit, to preferentially ensure that a composition task of the composition thread is executed on the second processing unit, and improve smoothness of the electronic device as much as possible.

In a possible design, the first operation includes an operation of starting a first application, and the first task is a layer composition task. That the first thread executes, on the second processing unit, the first task associated with the first operation includes: The first thread composes a startup animation effect of the first application on the second processing unit. The method further includes: displaying the startup animation effect on a display.

In other words, in a scenario in which a user starts the first application, in a process of composing the startup animation effect of the first application, when the composition thread is in a runnable state on a current processing unit, the electronic device may migrate the composition task of the composition thread to another processing unit, so that the composition thread composes the startup animation effect of the first application on the another processing unit. In this way, a layer composition progress can be accelerated, so that the electronic device can display the startup animation effect of the first application more quickly, and smoothness of the electronic device is improved.

In a possible design, the first operation includes an operation of starting a first application, and the first task is a send-for-display task. That the first thread executes, on the second processing unit, the first task associated with the first operation includes: The first thread transmits, on the second processing unit, a startup animation effect of the first application to a display. The method further includes: displaying the startup animation effect on the display.

In other words, in the scenario in which the user starts the first application, in a process of sending the startup animation effect of the first application for display, when the send-for-display thread is in a runnable state on a current processing unit, the electronic device may migrate a composition task of the send-for-display thread to another processing unit, so that the send-for-display thread performs sending for display of the startup animation effect on the another processing unit. In this way, a progress of sending the startup animation effect for display can be accelerated, so that the electronic device can display the startup animation effect of the first application more quickly, and smoothness of the electronic device is improved.

In a possible design, the first operation includes an operation of ending a first application, and the first task is a layer composition task. That the first thread executes, on the second processing unit, the first task associated with the first operation includes: The first thread composes an end animation effect of the first application on the second processing unit. The method further includes: displaying the end animation effect on a display.

In other words, in a scenario in which the user ends or exits the first application, in a process of composing the end animation effect of the first application, when the composition thread is in a runnable state on a current processing unit, the electronic device may migrate the composition task of the composition thread to another processing unit, so that the composition thread composes the end animation effect of the first application on the another processing unit. In this way, a layer composition progress can be accelerated, so that the electronic device can display the end animation effect of the first application more quickly, and smoothness of the electronic device is improved.

In a possible design, the first operation includes an operation of ending a first application, and the first task is a send-for-display task. That the first thread executes, on the second processing unit, the first task associated with the first operation includes: The first thread transmits, on the second processing unit, an end animation effect of the first application to a display. The method further includes: displaying the end animation effect on the display.

In other words, in the scenario in which the user ends or exits the first application, in a process of sending the end animation effect of the first application for display, when the send-for-display thread is in a runnable state on a current processing unit, the electronic device may migrate a composition task of the send-for-display thread to another processing unit, so that the send-for-display thread performs sending for display of the end animation effect on the another processing unit. In this way, a progress of sending the end animation effect for display can be accelerated, so that the electronic device can display the end animation effect of the first application more quickly, and smoothness of the electronic device is improved.

In a possible design, a preset field of the first thread is set to a preset value. In this way, the electronic device may determine a type of the first thread, and dynamically migrate, based on the type of the first thread, a task of the first thread in the runnable state, to improve performance of the electronic device.

According to a second aspect, a thread scheduling method is provided. The method includes: An electronic device receives a first operation. The electronic device detects that a first thread is in a runnable state on a first processing unit, and a second thread runs on the first processing unit. The electronic device determines whether duration in which the first thread is in the runnable state exceeds a threshold; and when the duration in which the first thread is in the runnable state does not exceed the threshold, executes a first task of the first thread on the first processing unit; or when the duration in which the first thread is in the runnable state exceeds the threshold, migrates the first task from the first processing unit to a second processing unit. The first thread includes a composition thread or a send-for-display thread, and a priority of the first thread is lower than a priority of the second thread. The first task includes a layer composition task or a send-for-display task.

In other words, when time in which the first thread is in the runnable state exceeds the threshold, it means that a task of the first thread is greatly affected. In this case, to improve smoothness of the electronic device, the electronic device may migrate the task of the first thread to another processing unit. On the contrary, when the time in which the first thread is in the runnable state does not exceed the threshold, a task of the second thread has been executed on the first processing unit. In this case, the first thread does not need to wait on the first processing unit or transit to another processing unit, but may directly execute the first task on the first processing unit.

According to a third aspect, a thread scheduling apparatus is provided, and is used in an electronic device or a component that can implement a function of an electronic device, for example, a chip system. The apparatus includes a processor, configured to: receive a first operation; detect that a first thread is in a runnable state on a first processing unit, and a second thread runs on the first processing unit; and migrate a first task of the first thread to a second processing unit, so that the first thread executes, on the second processing unit, the first task associated with the first operation, where the first task includes a layer composition task or a send-for-display task. The first thread includes a composition thread or a send-for-display thread, and a priority of the first thread is lower than a priority of the second thread.

In a possible design, that the processor is configured to migrate a first task of the first thread to a second processing unit includes: when detecting that duration in which the first thread is in the runnable state exceeds a threshold, migrating the first task of the first thread to the second processing unit.

In a possible design, a third thread runs on the second processing unit, a priority of the third thread is lower than the priority of the first thread, and that the first thread executes, on the second processing unit, the first task associated with the first operation includes: The first thread preempts the third thread and executes the first task on the second processing unit.

In a possible design, the first operation includes an operation of starting a first application, and the first task is a layer composition task. That the first thread executes, on the second processing unit, the first task associated with the first operation includes: The first thread composes a startup animation effect of the first application on the second processing unit. The apparatus further includes: a display, configured to display the startup animation effect composed by the composition thread.

In a possible design, the first operation includes an operation of starting a first application, and the first task is a send-for-display task. That the first thread executes, on the second processing unit, the first task associated with the first operation includes: The first thread transmits, on the second processing unit, a startup animation effect of the first application to a display. The display is configured to display the startup animation effect.

In a possible design, the first operation includes an operation of ending a first application, and the first task is a layer composition task. That the first thread executes, on the second processing unit, the first task associated with the first operation includes: The first thread composes an end animation effect of the first application on the second processing unit. A display is further configured to display the end animation effect.

In a possible design, the first operation includes an operation of ending a first application, and the first task is a send-for-display task. That the first thread executes, on the second processing unit, the first task associated with the first operation includes: The first thread transmits, on the second processing unit, an end animation effect of the first application to a display. The display is further configured to display the end animation effect.

In a possible design, a preset field of the first thread is set to a preset value.

According to a fourth aspect, a thread scheduling apparatus is provided, including:
a processor, configured to: receive a first operation; detect that a first thread is in a runnable state on a first processing unit, and a second thread runs on the first processing unit; determine whether duration in which the first thread is in the runnable state exceeds a threshold; and when the duration in which the first thread is in the runnable state does not exceed the threshold, execute a first task of the first thread on the first processing unit; or when the duration in which the first thread is in the runnable state exceeds the threshold, migrate the first task from the first processing unit to a second processing unit. The first thread includes a composition thread or a send-for-display thread, and a priority of the first thread is lower than a priority of the second thread. The first task includes a layer composition task or a send-for-display task.

According to a fifth aspect, an embodiment of this application provides an electronic device. The electronic device has a function of implementing the method according to any aspect and any one of the possible implementations of the foregoing aspect; or the electronic device has a function of implementing the method according to any aspect and any one of the possible implementations of the foregoing aspect. The function may be implemented by hardware, or may be implemented by hardware executing corresponding software. The hardware or the software includes one or more modules corresponding to the function.

According to a sixth aspect, an embodiment of this application provides a computer-readable storage medium. The computer-readable storage medium stores a computer program, and when the computer program is executed by an electronic device, the electronic device is enabled to perform the method according to any aspect or any one of the implementations of the aspect. In some embodiments, the computer program may also be referred to as instructions or code.

According to a seventh aspect, an embodiment of this application provides a computer program product. When the computer program product runs on an electronic device, the electronic device is enabled to perform the method according to any aspect or any one of the implementations of the aspect.

According to an eighth aspect, an embodiment of this application provides a circuit system, where the circuit system includes a processing circuit, and the processing circuit is configured to perform the method according to any aspect or any one of the implementations of the aspect.

According to a ninth aspect, an embodiment of this application provides a chip system, including at least one processor and at least one interface circuit. The at least one interface circuit is configured to perform a transceiver function, and send instructions to the at least one processor. When the at least one processor executes the instructions, the at least one processor performs the method according to any aspect or any one of the implementations of the aspect.

### BRIEF DESCRIPTION OF THE DRAWINGS

FIG. 1(a) to FIG. 1(d) are a diagram of an interface of a startup animation effect of an application according to an embodiment of this application;

FIG. 2 is a diagram of a structure of an electronic device according to an embodiment of this application;

FIG. 3 is a diagram of a software structure of an electronic device according to an embodiment of this application;

FIG. 4 is a diagram of a running status of a thread according to an embodiment of this application;

FIG. 5 is a diagram of a thread scheduling method according to an embodiment of this application;

FIG. 6 is another diagram of a structure of an electronic device according to an embodiment of this application;

FIG. 7 is a diagram of a thread scheduling method in a conventional technology;

FIG. 8 is a diagram of a thread scheduling method according to an embodiment of this application;

FIG. 9 is another diagram of a thread scheduling method according to an embodiment of this application;

FIG. 10 is a schematic flowchart of a thread scheduling method according to an embodiment of this application;

FIG. 11 to FIG. 14 each are another diagram of a thread scheduling method according to an embodiment of this application;

FIG. 15 is a diagram of a structure of a thread scheduling apparatus according to an embodiment of this application; and

FIG. 16 is a diagram of a structure of a chip system according to an embodiment of this application.

### DETAILED DESCRIPTION OF ILLUSTRATIVE EMBODIMENTS

In the descriptions of embodiments of this application, “/” represents “or” unless otherwise specified. For example, A/B may represent A or B. In this specification, “and/or” describes only an association relationship between associated objects and represents that three relationships may exist. For example, A and/or B may represent the following three cases: Only A exists, both A and B exist, and only B exists.

The terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features. In the descriptions of embodiments of this application, “a plurality of” means two or more than two unless otherwise specified.

In embodiments of this application, the word “example”, “for example” or the like is used to represent giving an example, an illustration, or a description. Any embodiment or design scheme described as an “example” or “for example” in embodiments of this application should not be explained as being more preferred or having more advantages than another embodiment or design scheme. Exactly, use of the word “example”, “for example”, or the like is intended to present a related concept in a specific manner.

In some scenarios, based on display content, an application animation effect in an electronic device may include two parts of animation effect elements: an application icon (Icon) animation effect and an application window (window) animation effect. Based on a use scenario of an application, an application animation effect may include an application startup animation effect and an application exit animation effect (or referred to as an application end animation effect). In a conventional technology, due to a limitation of a hardware configuration or the like, for example, a limitation of a memory or processor version, in a process of starting or ending an application, an application animation effect is frozen, which reduces smoothness of the electronic device, and affects user experience.

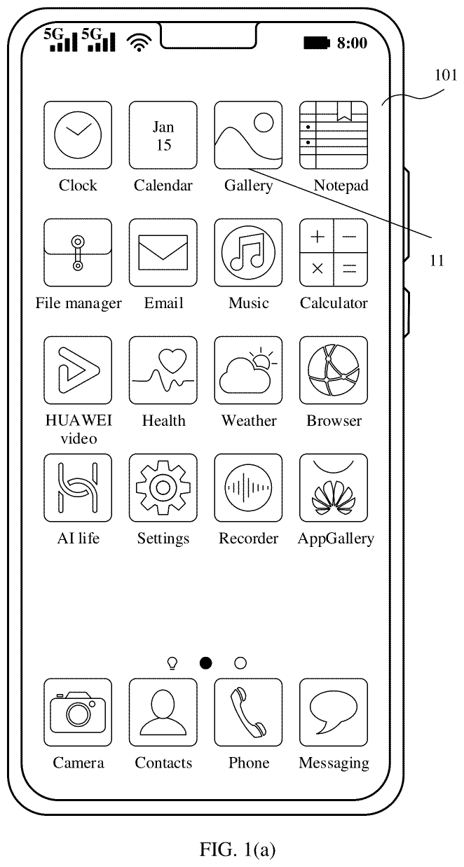

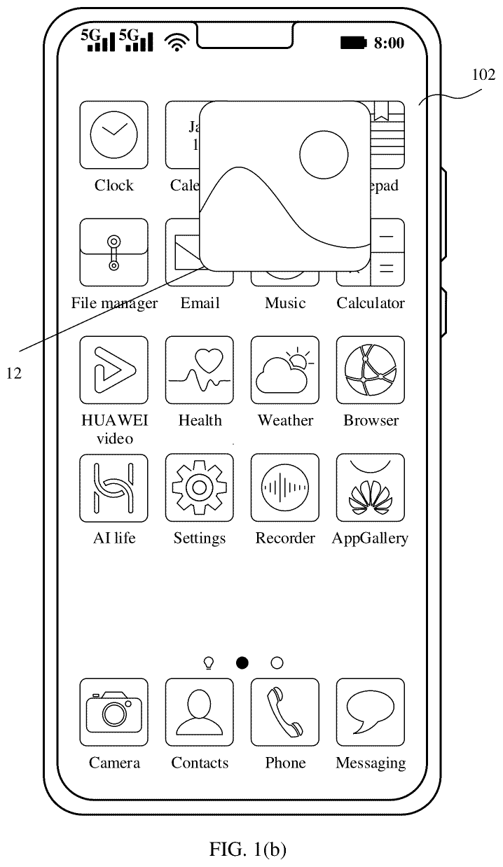

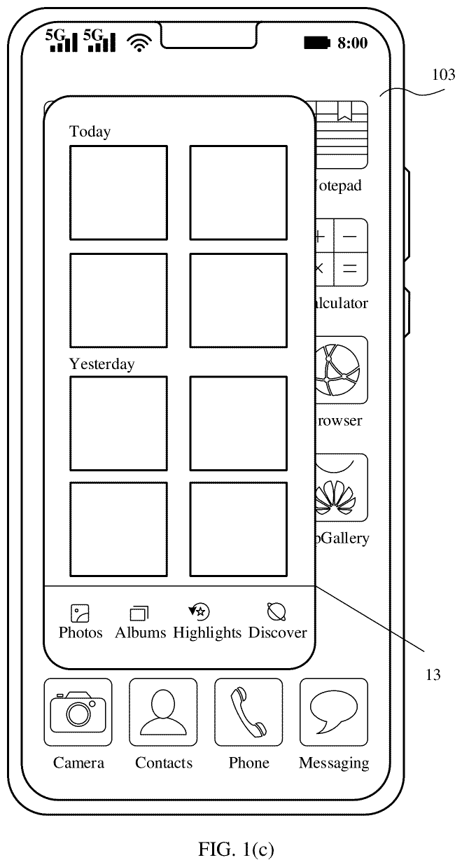

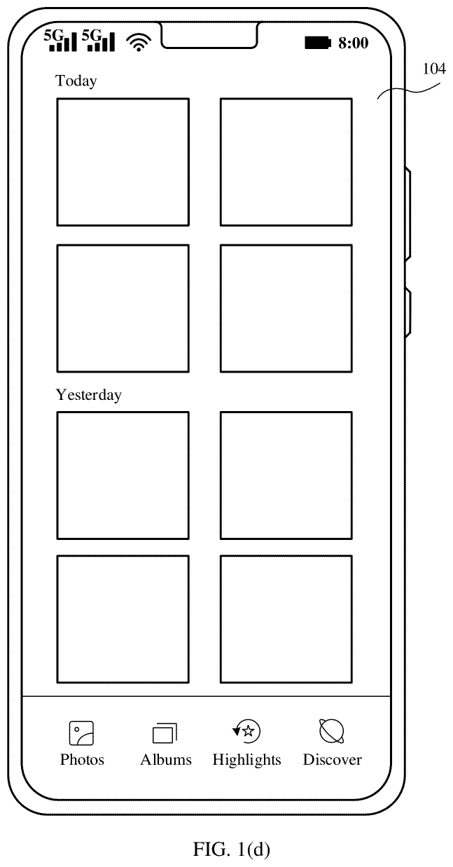

For example, on an interface 101 shown in FIG. 1(a), after detecting an operation of tapping a gallery icon 11 by a user, the electronic device displays an application icon animation effect, for example, zooms in the icon for display. On an interface 102 shown in FIG. 1(b), an icon indicated by a reference mark 12 is an icon display effect at a moment in the process of zooming in the icon. Then, the electronic device displays an application window animation effect, for example, zooms in an application window for display. On an interface 103 shown in FIG. 1(c), an application window indicated by a reference mark 13 is an application window display effect at a moment in the process of displaying the application window animation effect. In a conventional technology, for example, because a large quantity of background applications are started, and a temperature of a device body is high, a startup animation effect of an application is likely to be frozen. For example, the electronic device may maintain the interface 103 shown in FIG. 1(c) for a long time period. After the application window animation effect is displayed, the electronic device completes display of an application startup animation effect, for example, displays an interface 104 that is shown in FIG. 1(d) and on which a gallery window is displayed in full screen, to complete startup of a gallery application.

It can be learned that, in the scenarios shown in FIG. 1(a) to FIG. 1(d), the electronic device may display an interface and always keep the interface, and screen freezing occurs on the electronic device. This affects user experience.

To reduce a probability of screen freezing of the electronic device, embodiments of this application provide a thread scheduling method. In the method, when it is detected that duration in which an important thread like a composition thread is in a runnable state on an initial processing unit exceeds a threshold, the electronic device may migrate a task of the important thread from the initial processing unit to a target processing unit, to reduce scheduling time of the important thread, so that the important thread can obtain a use right of the target processing unit in a timely manner and execute the task related to a system response delay. In this way, freezing of the electronic device is avoided, and response smoothness of the electronic device is improved.

The thread scheduling method in embodiments of this application may be applied to the electronic device. For example, the electronic device may be, for example, a device like a mobile phone, a tablet computer, a personal computer (personal computer, PC), a netbook, a wearable device, or a vehicle-mounted device. A specific form of the electronic device is not specially limited in this application.

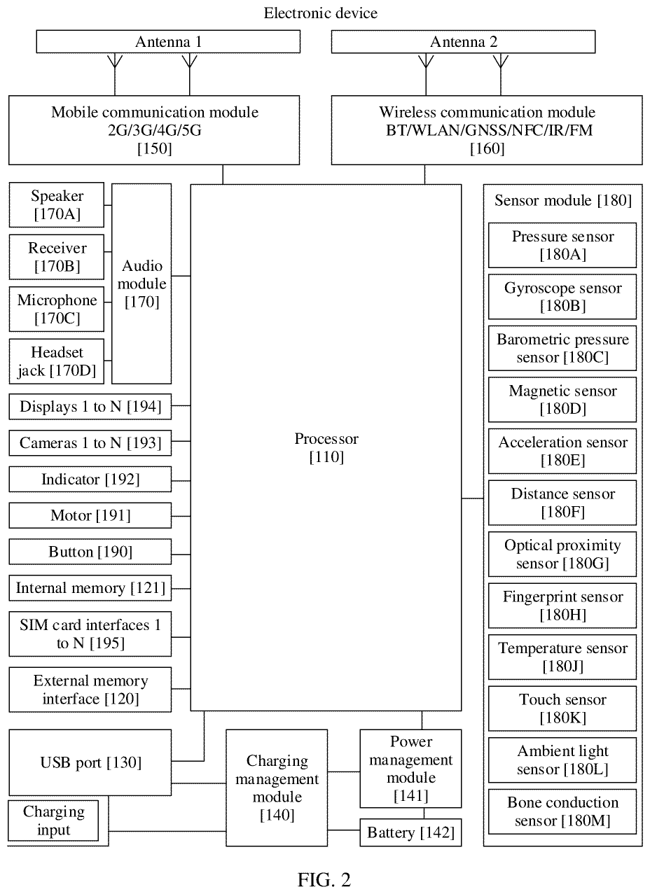

For example, the electronic device is a mobile phone. FIG. 2 is a diagram of a hardware structure of the electronic device 100. For a structure of another electronic device, refer to a structure of the electronic device 100.

The electronic device 100 may include a processor 110, an external memory interface 120, an internal memory 121, a universal serial bus (universal serial bus, USB) port 130, a charging management module 140, a power management module 141, a battery 142, an antenna 1, an antenna 2, a mobile communication module 150, a wireless communication module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (subscriber identification module, SIM) card interface 195, and the like. The sensor module 180 may include a pressure sensor 180A, a gyroscope sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that the structure shown in this embodiment of the present invention does not constitute a specific limitation on the electronic device 100. In some other embodiments of this application, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural-network processing unit (NPU), and/or the like. Different processing units may be independent devices, or may be integrated into one or more processors.

For example, in an electronic device having a multi-core processor, each processor core may be used as an independent processing unit. For example, if the electronic device is an octa-core processor, each core may be used as an independent processing unit.

The controller may generate an operation control signal based on an instruction operation code and a time sequence signal, to complete control of instruction reading and instruction execution.

A memory may be further disposed in the processor 110, and is configured to store instructions and data. In some embodiments, the memory in the processor 110 is a cache memory. The memory may store instructions or data just used or cyclically used by the processor 110. If the processor 110 needs to use the instructions or the data again, the processor may directly invoke the instructions or the data from the memory. This avoids repeated access, reduces waiting time of the processor 110, and improves system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) port, and/or the like.

The USB port 130 is a port that conforms to a USB standard specification, and may be specifically a mini USB port, a micro USB port, a USB Type-C port, or the like. The USB port 130 may be used to connect to a charger to charge the electronic device 100, or may be used to transmit data between the electronic device 100 and a peripheral device, or may be used to connect to a headset for playing audio through the headset. The interface may be further configured to connect to another electronic device like an AR device.

It may be understood that an interface connection relationship between the modules that is shown in this embodiment of the present invention is merely an example for description, and does not constitute a limitation on the structure of the electronic device 100. In some other embodiments of this application, the electronic device 100 may alternatively use an interface connection manner different from that in the foregoing embodiment, or use a combination of a plurality of interface connection manners.

The charging management module 140 is configured to receive a charging input from the charger. The charger may be a wireless charger or a wired charger. In some embodiments of wired charging, the charging management module 140 may receive a charging input of a wired charger through the USB port 130. In some embodiments of wireless charging, the charging management module 140 may receive a wireless charging input through a wireless charging coil of the electronic device 100. When charging the battery 142, the charging management module 140 may further supply power to a terminal through the power management module 141.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may be further configured to monitor parameters such as a battery capacity, a battery cycle count, and a state of health (electric leakage or impedance). In some other embodiments, the power management module 141 may alternatively be disposed in the processor 110. In some other embodiments, the power management module 141 and the charging management module 140 may alternatively be disposed in a same device.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that includes 2G/3G/4G/5G or the like and that is applied to the electronic device 100. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some function modules in the mobile communication module 150 may be disposed in the processor 110. In some embodiments, at least some function modules of the mobile communication module 150 may be disposed in a same device as at least some modules of the processor 110.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal through an audio device (which is not limited to the speaker 170A, the receiver 170B, or the like), or displays an image or a video through the display 194. In some embodiments, the modem processor may be an independent device. In some other embodiments, the modem processor may be independent of the processor 110, and is disposed in a same device as the mobile communication module 150 or another function module.

The wireless communication module 160 may provide a wireless communication solution that is applied to the electronic device 100 and that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like. The wireless communication module 160 may be one or more components integrating at least one communication processor module. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert the signal into an electromagnetic wave for radiation through the antenna 2.

In some embodiments of this application, the electronic device 100 may establish a wireless connection with another terminal or server through the wireless communication module 160 and the antenna 2, to implement communication between the electronic device 100 and the another terminal or server.

In some embodiments, the antenna 1 and the mobile communication module 150 in the electronic device 100 are coupled, and the antenna 2 and the wireless communication module 160 in the electronic device 100 are coupled, so that the electronic device 100 can communicate with a network and another device by using a wireless communication technology. The wireless communication technology may include a global system for mobile communications (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or satellite based augmentation systems (SBAS).

The electronic device 100 may implement a display function through the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs, which execute program instructions to generate or change display information.

The display 194 is configured to display an image, a video, and the like. The display 194 includes a display panel. The display panel may be a liquid crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like. In some embodiments, the electronic device 100 may include one or N displays 194, where N is a positive integer greater than 1.

The electronic device 100 may implement an image shooting function through the ISP, the camera 193, the video codec, the GPU, the display 194, the application processor, and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image. The ISP may further perform algorithm optimization on noise, and brightness of the image. The ISP may further optimize parameters such as exposure and a color temperature of an image shooting scenario. In some embodiments, the ISP may be disposed in the camera 193.

The camera 193 is configured to capture a static image or a video. An optical image of an object is generated through the lens, and is projected onto a photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format like RGB or YUV. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transformation on frequency energy.

The video codec is configured to compress or decompress a digital video. The electronic device 100 may support one or more video codecs. In this way, the electronic device 100 may play back or record videos in a plurality of coding formats, for example, moving picture experts group (MPEG)-1, MPEG-2, MPEG-3, and MPEG-4.

The NPU is a neural-network (NN) computing processor. The NPU quickly processes input information by referring to a structure of a biological neural network, for example, a transfer mode between human brain neurons, and may further continuously perform self-learning. Applications such as intelligent cognition of the electronic device 100 may be implemented through the NPU, for example, image recognition, facial recognition, speech recognition, and text understanding.

The external memory interface 120 may be used to connect to an external storage card, for example, a micro SD card, to extend a storage capability of the electronic device 100. The external memory card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage region and a data storage region. The program storage region may store an operating system, an application required by at least one function (for example, a voice playing function or an image playing function), and the like. The data storage region may store data (such as audio data and an address book) created during use of the electronic device 100, and the like. In addition, the internal memory 121 may include a high-speed random access memory, or may include a non-volatile memory, for example, at least one magnetic disk storage device, a flash memory device, or a universal flash storage (UFS). The processor 110 runs the instructions stored in the internal memory 121 and/or the instructions stored in the memory disposed in the processor, to perform various function applications and data processing of the electronic device 100.

The electronic device 100 may implement an audio function, for example, music playing and recording, through the audio module 170, the speaker 170A, the receiver 170B, the microphone 170C, the headset jack 170D, the application processor, and the like.

The audio module 170 is configured to convert digital audio information into an analog audio signal for output, and is also configured to convert an analog audio input into a digital audio signal. The audio module 170 may be further configured to encode and decode an audio signal. In some embodiments, the audio module 170 may be disposed in the processor 110, or some function modules in the audio module 170 are disposed in the processor 110.

The speaker 170A, also referred to as a “loudspeaker”, is configured to convert an electrical audio signal into a sound signal. The electronic device 100 may be used to listen to music or answer a call in a hands-free mode over the speaker 170A.

The receiver 170B, also referred to as an “earpiece”, is configured to convert an electrical audio signal into a sound signal. When a call is answered or a voice message is received through the electronic device 100, the receiver 170B may be put close to a human ear to listen to a voice.

The microphone 170C, also referred to as a “mike” or a “mic”, is configured to convert a sound signal into an electrical signal. When making a call or sending a voice message, a user may make a sound near the microphone 170C through the mouth of the user, to input a sound signal to the microphone 170C. At least one microphone 170C may be disposed in the electronic device 100. In some other embodiments, two microphones 170C may be disposed in the electronic device 100, to collect a sound signal and implement a noise reduction function. In some other embodiments, three, four, or more microphones 170C may alternatively be disposed in the electronic device 100, to collect a sound signal, implement noise reduction, and identify a sound source, so as to implement a directional recording function and the like.

The headset jack 170D is configured to connect to a wired headset. The headset jack 170D may be a USB port 130, or may be a 3.5 mm open mobile terminal platform (OMTP) standard interface or cellular telecommunications industry association of the USA (CTIA) standard interface.

The button 190 includes a power button, a volume button, and the like. The button 190 may be a mechanical button, or may be a touch button. The electronic device 100 may receive a button input, and generate a button signal input related to a user setting and function control of the electronic device 100.

The motor 191 may generate a vibration prompt. The motor 191 may be configured to provide an incoming call vibration prompt and a touch vibration feedback. For example, touch operations performed on different applications (for example, photographing and audio playback) may correspond to different vibration feedback effects. The motor 191 may also correspond to different vibration feedback effects for touch operations performed on different regions of the display 194. Different application scenarios (for example, a time reminder, information receiving, an alarm clock, and a game) may also correspond to different vibration feedback effects. The touch vibration feedback effect may be further user-defined.

The indicator 192 may be an indicator light, and may be configured to indicate a charging status and a state of charge change, or may be configured to indicate a message, a missed call, a notification, and the like.

The SIM card interface 195 is used to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1. The SIM card interface 195 may support a nano-SIM card, a micro-SIM card, a SIM card, and the like. A plurality of cards may be inserted into a same SIM card interface 195 at the same time. The plurality of cards may be of a same type or different types. The SIM card interface 195 may also be compatible with different types of SIM cards. The SIM card interface 195 may also be compatible with an external storage card. The electronic device 100 interacts with a network through the SIM card, to implement functions such as conversation and data communication. In some embodiments, the electronic device 100 uses an eSIM. The eSIM card may be embedded into the electronic device 100, and cannot be separated from the electronic device 100.

It should be noted that, for a structure of the electronic device, refer to the structure shown in FIG. 2. The electronic device may have more or fewer components than those in the structure shown in FIG. 2, or some components may be combined, or some components may be split, or different component arrangements may be used. The components shown in the figure may be implemented by hardware, software, or a combination of software and hardware.

In some embodiments, a software system of the electronic device 100 may use a layered architecture, an event-driven architecture, a microkernel architecture, a micro service architecture, or a cloud architecture. In embodiments of the present invention, an Android® system of a layered architecture is used as an example to illustrate the software structure of the electronic device 100.

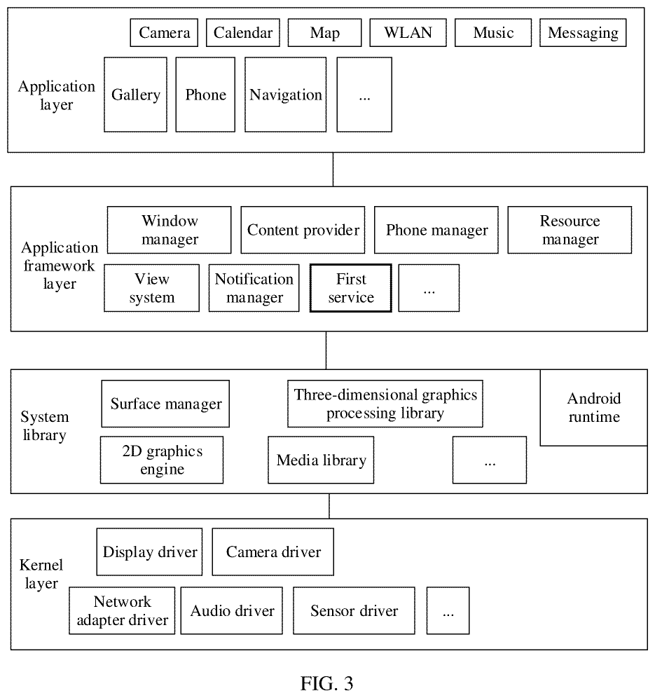

FIG. 3 is a block diagram of a software structure of the electronic device 100 according to an embodiment of the present invention.

In a layered architecture, software is divided into several layers, and each layer has a clear role and task. The layers communicate with each other through a software interface. In some embodiments, the Android system is divided into four layers: an application layer, an application framework layer, an Android runtime and system library, and a kernel layer from top to bottom.

The application layer may include a series of application packages.

As shown in FIG. 3, the application packages may include applications such as Camera, Gallery, Calendar, Phone, Map, Navigation, WLAN, Bluetooth, Music, Videos, and Messaging.

The application may run in a software system of the electronic device 100 in a form of one or more processes. One process may include one or more threads.

One or more applications may run in the electronic device, and each application has at least one corresponding process. One process has at least one thread that is executing a task (task). In other words, a plurality of threads run in the electronic device. To ensure normal running of a thread, the electronic device may allocate a processing unit, for example, allocate a CPU core, to the thread according to a specific strategy. After the processing unit is allocated to the thread, the processing unit may be used to execute a corresponding task.

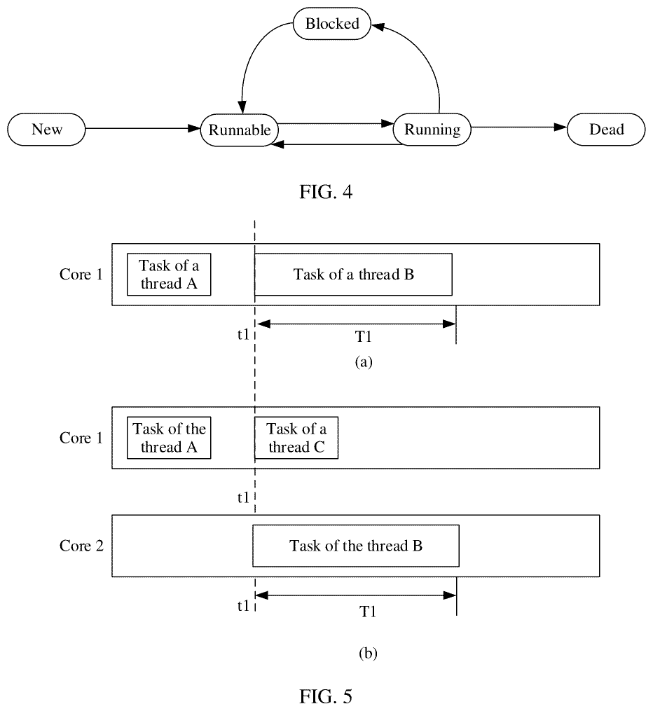

In some embodiments, a thread may have different states based on a life cycle of the thread. For example, as shown in FIG. 4, a thread status includes states such as a new state, a runnable state, a running state, a blocked state, and a dead state.

In some embodiments, a thread may be in a new state after being created. The runnable state may also be referred to as a state in which running is available.

The thread in the new state may enter a runnable state in some manners. For example, the thread in the new state may invoke a start ( ) method to trigger the thread to enter the runnable state. After entering the runnable state, the thread is ready for running, is added to a runnable queue, and waits for CPU scheduling, to execute a corresponding task.

If the thread in the runnable state is scheduled by a CPU, the thread may enter a running state to execute the corresponding task. The thread in the running state may be added to a running queue of the electronic device.

For the thread in the running state, when a specific condition is met, the thread may switch from the running state back to the runnable state. For example, if the running thread is preempted by another thread with a higher priority, and loses a right to use the CPU, the thread may switch from the running state to the runnable state. In some other cases, if the thread gives up the right to use the CPU for a reason, for example, a CPU time slice is released, the thread stops running temporarily and enters a blocked state. The thread in the blocked state cannot be added to the runnable queue, but can be added to a blocked queue. When some events are triggered, for example, an I/O device that the thread waits for is idle, the thread may change from the blocked state to the runnable state, and the thread may be added to the runnable queue again. After the thread that is added to the runnable queue again is selected by the electronic device, the thread may continue to run from an original stop location.

In some cases, the thread in the running state executes a task of the thread. When a condition is met, for example, a condition for completing the task is met, the thread enters a dead state.

In some embodiments, the electronic device may maintain different queues corresponding to various states of threads. For example, the queues may include but are not limited to one or more of the following queues: a runnable queue, a running queue, and a blocked queue. The runnable queue is used to store a thread in a runnable state, the running queue is used to store a thread in a running state, and the blocked queue is used to store a thread in a blocked state.

For example, when detecting that a thread enters a runnable state, the electronic device may add the thread to the runnable queue. When a specific condition is met, the CPU of the electronic device may schedule a thread in the runnable queue, and may add the thread to the running queue. For another example, when detecting that a thread enters a running state, the electronic device may add the thread to the running queue. For another example, when detecting that a thread enters a blocked state, the electronic device may add the thread to the blocked queue. When a specific condition is met, the thread may switch from the blocked state to a runnable state, and be added to the runnable queue.

In some embodiments, each thread may correspond to one priority, and a thread with a higher priority is more likely to obtain a running resource. In an example, each thread may correspond to one priority value. A higher priority value indicates a lower priority, and vice versa. For example, it is assumed that a priority value of a composition thread is 120, and a priority value of a real-time thread is 99, a priority of the real-time thread is higher than a priority of the composition thread. In some cases, for example, when running resources of the CPU are limited, the real-time thread easily preempts a running resource of the composition thread.

It should be understood that a correspondence between a priority value and a priority is not limited in embodiments of this application. In some other embodiments, a higher priority value of a thread indicates a higher priority; and on the contrary, a lower priority value of a thread indicates a lower priority.

For example, as shown in (a) in FIG. 5, at a moment t1, a thread B starts to execute a task by using a core 1 of a processor, and completes execution of the task after duration T1. As shown in (b) in FIG. 5, at a moment t1, a thread B wants to start to execute a task, but a thread C whose priority is higher than that of the thread B preempts a running resource of a core 1. Therefore, at the moment t1, the thread C starts to execute a task of the thread C by using the core 1.

To avoid a problem that execution of a thread with a lower priority is delayed when a thread with a higher priority preempts a running resource of the thread with the lower priority, in embodiments of this application, when the thread with the higher priority preempts the running resource of the thread with the lower priority, the thread with the lower priority may be migrated to another processing unit. Still as shown in (b) in FIG. 5, when the thread C with the higher priority preempts the running resource of the thread B on the core 1, the electronic device may migrate the thread B to a core 2 of the processor. In this way, the thread B can continue to execute the task on the core 2 without waiting for the thread C to complete execution. This helps improve execution efficiency of the thread B, improves task execution efficiency of the electronic device, and reduces a probability of freezing of the electronic device.

In a possible implementation, when a running resource of a thread with a lower priority on a current processing unit is preempted, the electronic device may determine a type of the thread with the lower priority, and determine, based on the type of the thread with the lower priority, whether to migrate the thread with the lower priority to another processing unit.

In some embodiments, when the thread with the lower priority whose running resource is preempted belongs to a thread of a preset type, the electronic device may migrate the thread with the lower priority to the another processing unit. The thread of the preset type includes but is not limited to a thread that has great impact on performance such as smoothness and a response delay of the electronic device. For example, the thread of the preset type includes a thread related to layer composition (composer) and a thread related to sending image for display. In some examples, a composition thread may be referred to as a kworker. Certainly, the composition thread may also have another name, and the thread name does not constitute an essential limitation on a solution like a function of the composition thread.

In some embodiments, the thread of the preset type may also be referred to as an important thread, a key thread, or the like. The response delay may also be referred to as an operation delay. The thread related to layer composition may be referred to as a composition thread, a layer composition thread, or the like for short.

It may be understood that, when the thread with the lower priority whose running resource is preempted has great impact on smoothness of the electronic device, for example, the thread with the lower priority whose running resource is preempted is a thread related to layer composition, the electronic device may migrate the thread with the priority to another processing unit to continue execution. This improves execution efficiency of the thread with the lower priority, and further improves performance such as the smoothness of the electronic device.

On the contrary, when the thread with the lower priority whose running resource is preempted does not belong to the thread of the preset type, because the thread with the lower priority has little impact on performance such as smoothness and a response speed of the electronic device, the electronic device may not migrate the thread with the lower priority, but wait for a task of the thread with the higher priority to be completed on the initial processing unit, and then execute the task of the thread with the lower priority on the initial processing unit.

The application framework layer provides an application programming interface (application programming interface, API) and a programming framework for an application at the application layer. The application framework layer includes some predefined functions.

In embodiment of this application, the framework layer may include a first service. The first service is used to mark a thread of a preset type. In some examples, the first service may be used to detect a type of a thread, and modify a corresponding field of the thread to represent whether the thread is a thread of the preset type. In some examples, a kernel (kernel) may obtain the type of the thread from the first service, and migrate the thread of the preset type from a non-idle processor core to an idle processor core based on the type of the thread.

As shown in FIG. 3, the application framework layer may include a window manager, a content provider, a view system, a phone manager, a resource manager, a notification manager, and the like.

The window manager is configured to manage a window program. The window manager may obtain a size of the display, determine whether there is a status bar, perform screen locking, take a screenshot, and the like.

The content provider is configured to: store and obtain data, and enable the data to be accessed by an application. The data may include a video, an image, audio, calls that are made and answered, a browsing history and a bookmark, a phone book, and the like.

The view system includes visual controls such as a control for displaying a text and a control for displaying a picture. The view system may be configured to establish an application. A display interface may include one or more views. For example, a display interface including an SMS message notification icon may include a text display view and an image display view.

The phone manager is configured to provide a communication function for the electronic device 100, for example, management of a call status (including answering, declining, or the like).

The resource manager provides various resources such as a localized character string, an icon, an image, a layout file, and a video file for an application program.

The notification manager enables an application program to display notification information in a status bar, and may be configured to convey a notification message. The notification manager may automatically disappear after a short pause without requiring a user interaction. For example, the notification manager is configured to notify download completion, give a message notification, and the like. The notification manager may alternatively be a notification that appears in a top status bar of the system in a form of a graph or a scroll bar text, for example, a notification of an application that is run on a background, or may be a notification that appears on the screen in a form of a dialog window. For example, text information is displayed in the status bar, an announcement is given, the electronic device vibrates, or the indicator light blinks.

The Android runtime includes a core library and a virtual machine. The Android runtime is responsible for scheduling and management of the Android system.

The core library includes two parts: a function that needs to be invoked in Java language, and a core library of Android.

The system library may include a plurality of function modules, for example, a surface manager, a media library, a three-dimensional graphics processing library (for example, OpenGL ES), and a 2D graphics engine (for example, SGL).

The surface manager is configured to manage a display subsystem and provide fusion of 2D and 3D layers for a plurality of applications.

The media library supports playback and recording in a plurality of commonly used audio and video formats, static image files, and the like. The media library may support a plurality of audio and video coding formats such as MPEG-4, H.264, MP3, AAC, AMR, JPG, and PNG.

The three-dimensional graphics processing library is configured to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, a sensor driver, a binder driver, and the like. The kernel layer provides security management, memory management, process management, network protocol stack and driver model management, and the like for an Android system service (system server). A system service process may invoke resources at the kernel layer to provide various system services, for example, an AMS, a PMS, and a WMS.

The foregoing shows only an example of a possible software architecture of the electronic device. The software architecture of the electronic device may alternatively be another architecture. This is not limited in embodiments of this application. The software architecture may alternatively be a software architecture based on a system like Harmony®. For example, the foregoing uses an example in which the first service is located at the framework layer. In some other embodiments, the first service may be located at another layer, or the first service may be split into a plurality of function modules, and different function modules may be disposed at different layers.

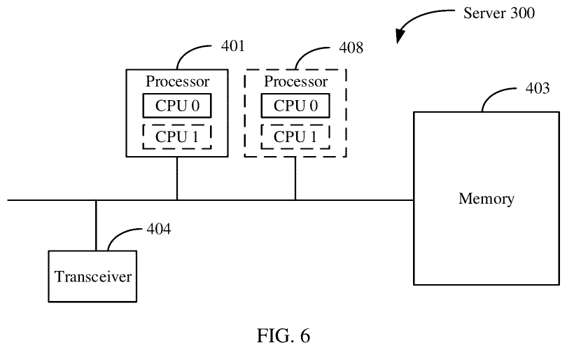

FIG. 6 shows another possible structure of an electronic device. The electronic device may include a processor 401, a memory 403, a transceiver 404, and the like. In addition, a processor 408 may be further included.

A path may be included between the foregoing components, and is used to transmit information between the foregoing components.

The transceiver 404 is configured to communicate with another device or communication network by using a protocol like Ethernet or a WLAN.

For detailed content of the processor and the memory, refer to descriptions of a related structure in the electronic device in FIG. 2. Details are not described herein again.

The following describes in detail the technical solutions provided in embodiments of this application. The technical solutions in embodiments of this application may be applied to an electronic device having a plurality of processing units. The processing unit may include but is not limited to a processor core. The following uses an example in which the processing unit is a processor core for description, but this does not constitute a limitation on the processing unit.

Various interfaces, for example, an application startup interface and an application exit interface, may be displayed on a display of the electronic device. The electronic device completes display of an application interface through processes such as drawing and rendering, layer composition, and delivery to the display (which may be referred to as sending for display).

For example, as shown in FIG. 1(a), after detecting that a user taps an icon 11 of a gallery application, the electronic device draws and renders an icon animation effect 12 shown in FIG. 1(b), to obtain layer data corresponding to the icon animation effect 12. Then, the electronic device invokes a composition thread to perform layer composition on a layer corresponding to the icon animation effect 12, to obtain a corresponding image, and sends the image to a display driver. For example, the composition thread sends the composed image to an LCD driver, and the LCD driver invokes an LCD to display the image of the icon animation effect 12. The image displayed on the LCD may be sensed by a human eye, to implement displaying of an application icon animation effect. Similarly, in an application startup process, the electronic device displays another startup animation effect, for example, draws and renders an application window 13 shown in FIG. 1(c), invokes the composition thread to compose an image corresponding to the application window 13, and sends the image of the application window 13 for display, so that a display module displays the image of the application window 13.

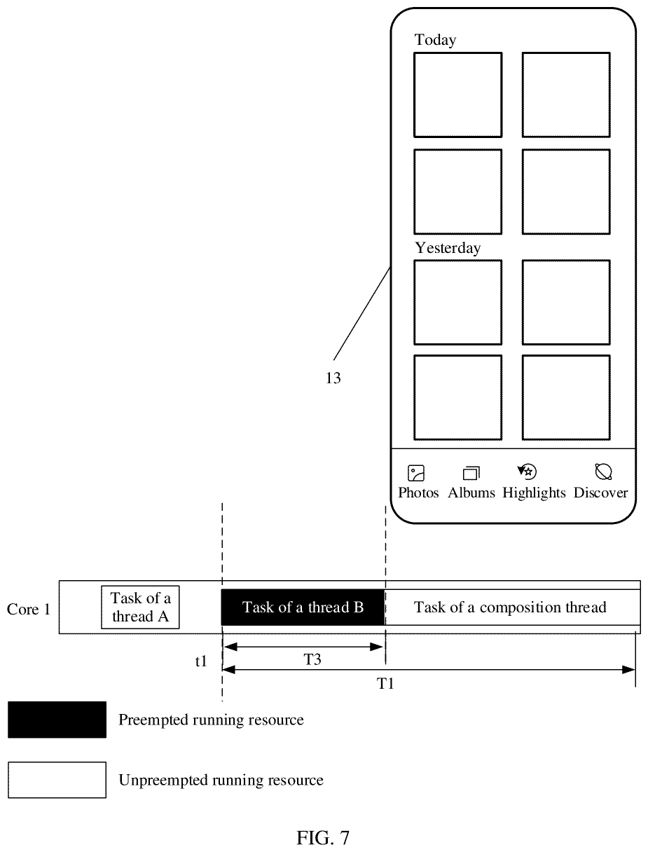

In a working process of the composition thread, a thread with a higher priority may preempt a running resource of the composition thread. As a result, the composition thread cannot compose an image of an application startup animation effect in a timely manner, and therefore cannot perform sending for display in a timely manner. Consequently, a screen of the electronic device is frozen. For example, in a conventional technology, as shown in FIG. 7, a task of a thread A runs on a core 1 of a processor. At a moment t1, the layer composition thread wants to execute a layer composition task. However, a thread B with a higher priority preempts the running resource of the layer composition thread, and the thread B executes a task of the thread B on the core 1. After the task of the thread B is executed, the composition thread obtains a right to use the core 1 and executes the layer composition task. It can be learned that, in this solution, the image of the application window 13 is delayed for composition. For example, in FIG. 7, image composition starts after a delay of T3, and a screen of the electronic device is frozen.

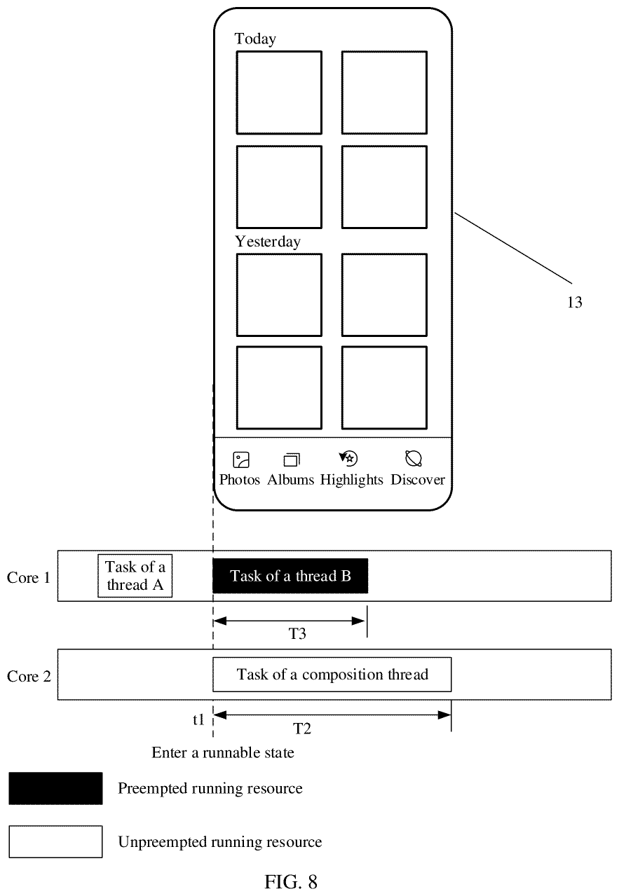

In embodiments of this application, to reduce a probability of freezing of the electronic device as much as possible, a thread related to a performance indicator like smoothness and a response speed of the electronic device may be determined, and a task of the thread of this type may be dynamically migrated between different processing units, to reduce a probability that execution of the thread of this type is delayed. As shown in FIG. 8, a task of a thread A runs on a core 1 of a processor. At a moment t1, the composition thread wants to execute a layer composition task. However, a thread B with a higher priority preempts the running resource of the composition thread, the thread B executes a task of the thread B on the core 1, and the composition thread is in a runnable state. In this case, the electronic device may migrate the composition thread to another idle core, and continue to execute the task of the composition thread. As shown in FIG. 8, the task of the composition thread may be migrated from the core 1 to a core 2. In this way, the task of the composition thread can be prevented from being interrupted, and smoothness of an application startup or end animation effect can be improved.

For example, still as shown in FIG. 1(a), after detecting that the user taps the icon 11 of the gallery application, the electronic device schedules a render thread to render a startup animation effect, and schedules the composition thread to compose an image of the startup animation effect. For example, the composition thread is scheduled to compose the startup animation effect 12 of the application icon shown in FIG. 1(b). It is assumed that the composition thread is in a runnable queue of the CPU core 1, and a real-time thread with a higher priority is running on the CPU core 1. In this case, the electronic device may migrate a layer composition task of the composition thread to the CPU core 2, to avoid a problem of a composition delay that is of the startup animation effect 12 and that is caused because the composition thread waits to be scheduled by the CPU core 1 in the runnable queue of the CPU core 1.

It can be learned that, in the technical solutions of embodiments of this application, the layer composition task is dynamically migrated, so that the layer composition task can be executed in a timely manner. This helps reduce a response delay of the electronic device, improve running smoothness of the electronic device, and improve interaction experience. For example, the layer composition task is migrated to an idle CPU core, so that composition of the icon startup animation effect 12 shown in FIG. 1(b) and an application window startup animation effect 13 shown in FIG. 1(c) can be accelerated on the idle CPU core. In this way, in a process of starting the application, startup animation effects can be quickly and smoothly transited and displayed, and smoothness of the electronic device can be improved.

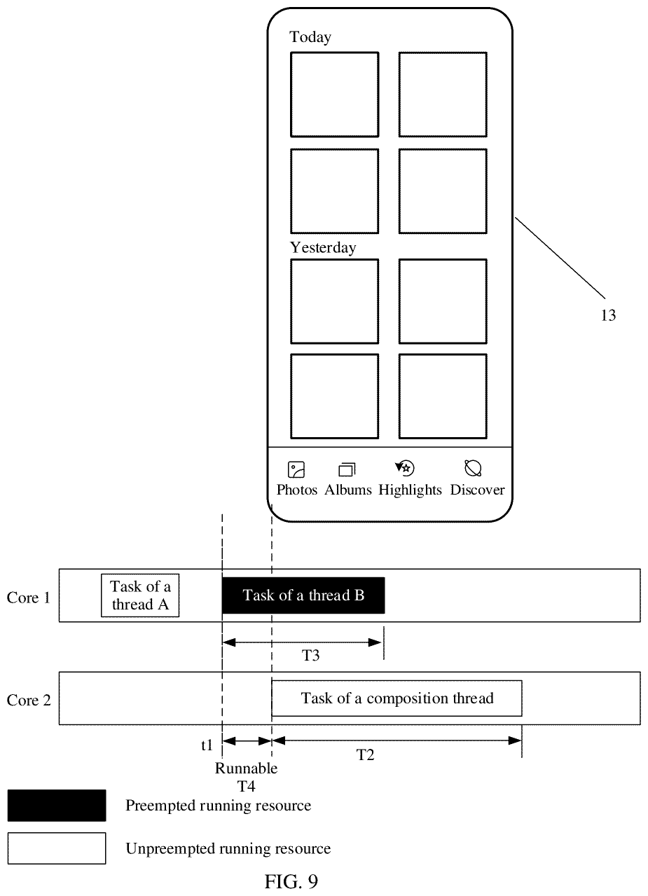

In some other embodiments, if duration in which the composition thread is in the runnable state does not reach a threshold, it indicates that the composition task of the composition thread is not greatly affected, or performance such as smoothness of the electronic device is not greatly affected. In this case, the task of the composition thread may be migrated after the duration in which the composition thread is in the runnable state exceeds the threshold. In this way, a probability that a task is incorrectly migrated can be reduced, and a task migration frequency can be reduced. Further, device power consumption caused thereby is reduced, and performance of the electronic device is improved. For example, as shown in FIG. 9, at a moment t1, the layer composition thread wants to execute a layer composition task, but a thread B with a higher priority preempts the running resource of the layer composition thread, and the composition thread is in the runnable state. Then, the composition thread continues to be in the runnable state. When the duration in which the composition thread is in the runnable state reaches T4, the electronic device may migrate the composition thread to another idle core to avoid long-term blocking of the composition thread. For example, the composition thread is migrated to a core 2, and the task of the composition thread continues to be executed on the core 2.

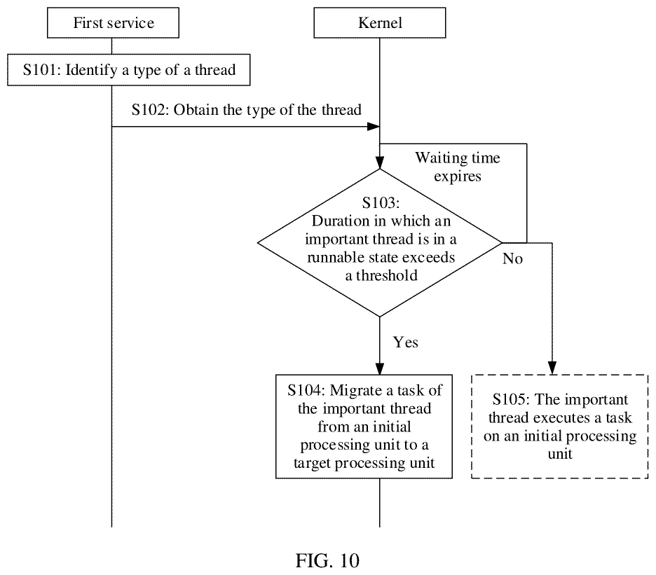

The following describes some technical details related to the foregoing method. FIG. 10 shows an example procedure of a thread scheduling method according to an embodiment of this application. The procedure includes the following steps.

S101: A first service identifies a type of a thread.

The type of the thread may include an important thread and an unimportant thread. The important thread may include a thread related to layer composition.

In some embodiments, the first service may be located at a framework layer.

In a possible implementation, the first service may identify the type of the thread, and mark a composition thread or the like as an important thread. The first service may represent, by modifying a corresponding field of the thread, whether the thread is an important thread.

S102: A kernel obtains the type of the thread from the first service.

S103: For an important thread, the kernel determines whether duration in which the important thread is in a runnable state exceeds a threshold. When the threshold is exceeded, the following step S104 is performed. When the threshold is not exceeded, the following step S105 is performed.

In some embodiments, the threshold may be dynamically set based on an actual requirement. For example, the threshold may be set to a value in a range of 2 ms to 10 ms.

In a possible implementation, when a specific condition is met, a CPU core (core) switching process of the kernel is triggered. Optionally, the condition includes but is not limited to detecting a clock interrupt instruction. After detecting the clock interrupt instruction, the kernel may detect duration in which the important thread is in the runnable state on an initial processing unit. When the duration expires, the kernel may determine a target processing unit, and migrate a task of the important thread to the target processing unit. In embodiments of this application, the initial processing unit may be referred to as a first processing unit, and the target processing unit may be referred to as a second processing unit.

S104: The kernel migrates the task of the important thread from the initial processing unit to the target processing unit.

The initial processing unit is a processing unit on which the important thread is currently located. Optionally, the target processing unit is a runnable processing unit. The target processing unit may be the following processing unit: a currently idle processing unit (with no running thread), a processing unit on which a thread with a lower priority is located, a processing unit on which no critical task is queued and no real-time task is performed, or another processing unit that can execute the task of the important thread in a timely manner.

In some embodiments, the thread with the lower priority refers to a thread whose priority is lower than that of the composition thread.

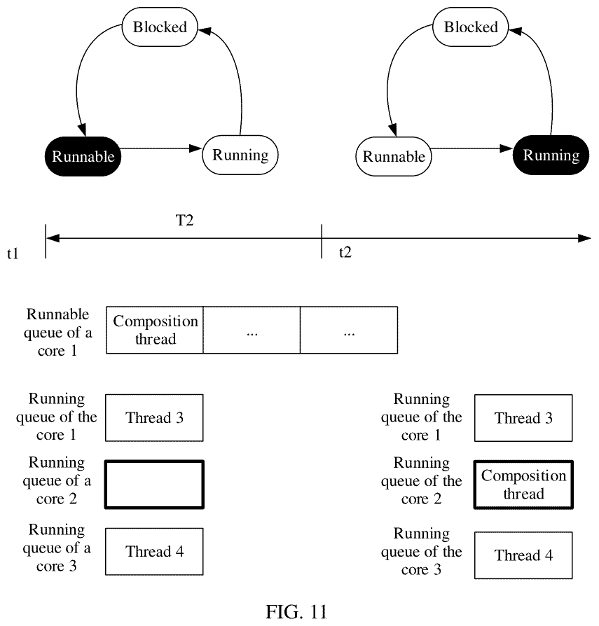

For example, the important thread is the composition thread. As shown in FIG. 11, at a moment t1, it is assumed that a thread 3 runs on a CPU core 1, and a priority of the thread 3 is higher than the priority of the composition thread. Because the composition thread cannot preempt a running resource of the thread 3 with the higher priority, the composition thread enters a runnable state, is added to a runnable queue of the CPU core 1 (an initial processing unit of the composition thread), and waits to be scheduled. Then, when a moment t2 arrives, if the kernel detects that duration in which the composition thread is in the runnable state reaches a threshold (for example, T2), the kernel may migrate the composition thread to another CPU core (the target processing unit), so that the composition thread executes a layer composition task on the another core, to reduce a probability that execution of the layer composition task is delayed, so as to improve smoothness of the electronic device.

In a possible manner, the kernel determines whether there is an idle CPU core currently. In some examples, if there is an idle CPU core, the composition thread may be migrated to the idle CPU core, so that the composition thread executes the layer composition task on the idle CPU core, to reduce a probability that execution of the layer composition task is delayed, so as to improve smoothness of the electronic device.

On the contrary, in some other examples, if there is no idle CPU core currently, the kernel may determine whether there is currently a CPU core on which a thread with a lower priority runs. If there is a CPU core on which a thread with a lower priority runs, the composition thread may be migrated to the CPU core. If there is no CPU core on which a thread with a lower priority runs, the composition thread is not migrated, and the composition thread still waits to be scheduled in the runnable queue of the initial processing unit.

For example, still as shown in FIG. 11, when the moment t2 arrives, the kernel detects that the duration in which the composition thread is in the runnable state reaches the threshold (for example, T2), and the kernel may detect whether there is an idle CPU core. It is detected that there is no thread in a running queue of a CPU core 2. In other words, the CPU core 2 is idle. In this case, the kernel may control the composition thread to be migrated to the CPU core 2, so that the composition thread may execute the layer composition task on the CPU core 2.

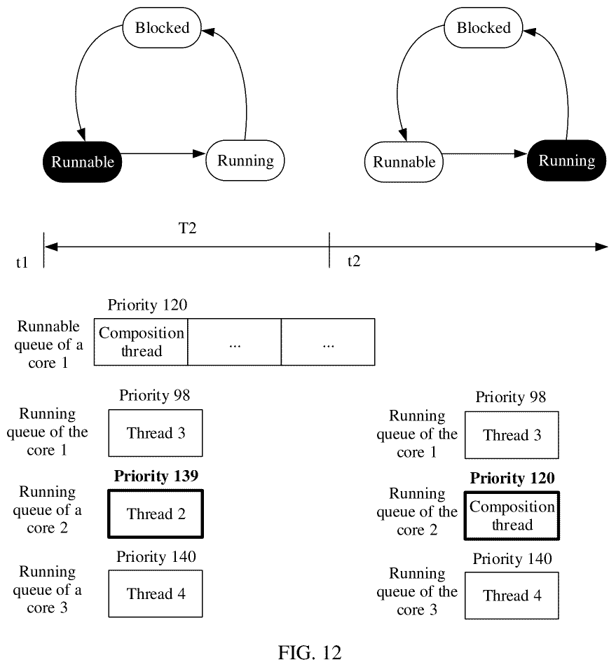

For another example, as shown in FIG. 12, when the moment t2 arrives, the kernel detects that duration in which the composition thread is in a runnable state reaches a threshold (for example, T2), and the kernel may detect whether there is an idle CPU core. It is detected that all CPU cores of the electronic device are not idle. In this case, the kernel may detect whether there is a CPU core on which a thread with a lower priority runs. It is detected that priorities of threads running on the CPU core 2 and a CPU core 3 are lower than the priority of the composition thread. In this case, the kernel may control the composition thread to be migrated to the CPU core 2 (or the CPU core 3), so that the composition thread may execute the layer composition task on the CPU core 2 (or the CPU core 3).

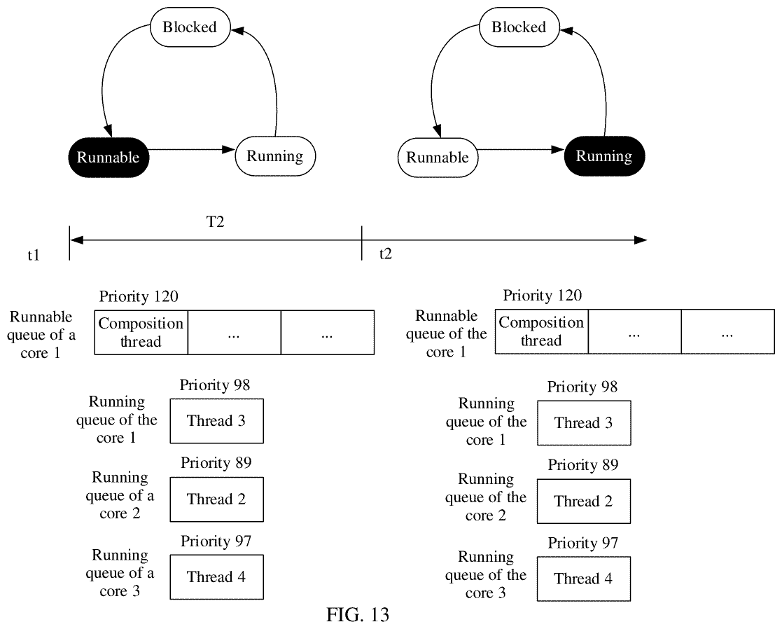

For another example, as shown in FIG. 13, when the moment t2 arrives, the kernel detects that the duration in which the composition thread is in the runnable state reaches the threshold (for example, T2). It is detected that all CPU cores of the electronic device are not idle, and a priority of a thread running in each core is higher than the priority of the composition thread. In this case, the kernel does not migrate the composition thread, and the composition thread still waits to be scheduled in the runnable queue of the CPU core 1.

Refer again to FIG. 10, in some examples, in addition to the foregoing steps S101 to S104, the thread scheduling method may further include the following steps.

S105: The important thread executes a task on an initial processing unit.

It may be understood that, for example, the important thread is a composition thread. When time for which the composition thread is in a runnable state on the initial processing unit does not exceed a threshold, a task of a real-time thread has been executed on the initial processing unit. In this case, the composition thread does not need to wait on the initial processing unit or transit to another processing unit, but may directly execute the composition task on the initial processing unit.

It should be understood that, based on an actual thread scheduling requirement, step S101 to step S105 may be combined, deleted, replaced, or the like, or another step may be added. This is not limited herein.

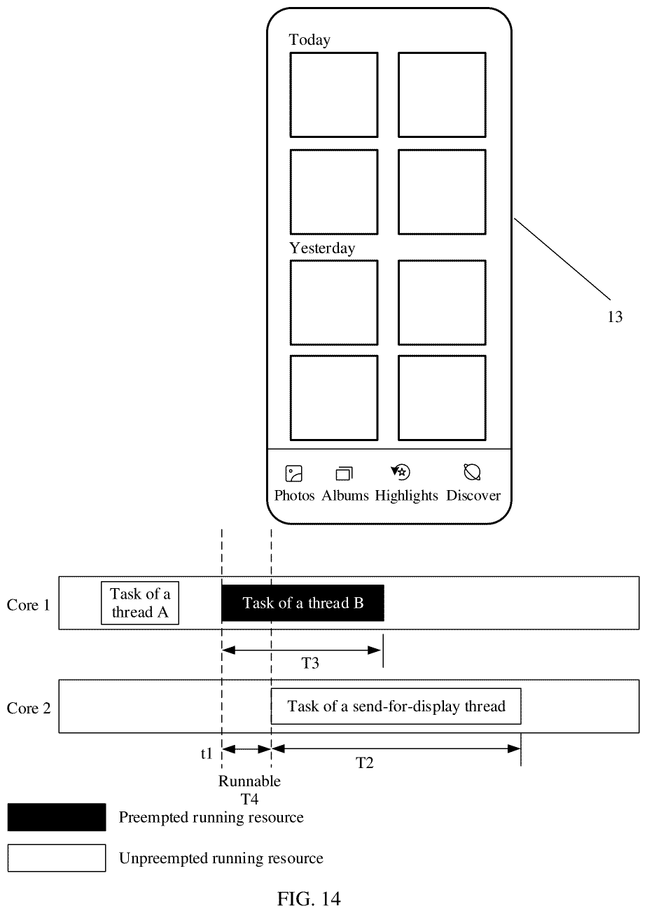

The foregoing mainly uses an example in which the important thread is a layer composition thread for description. In some other embodiments, the important thread may alternatively be another type of thread. For example, the important thread includes a send-for-display thread. For example, as shown in FIG. 14, at a moment t1, the send-for-display thread wants to execute a send-for-display task. However, a thread B with a higher priority preempts a running resource of the send-for-display thread (the thread B with the higher priority obtains a right to use a core 1), and the send-for-display thread enters a runnable state. Then, the send-for-display thread continues to be in the runnable state. When duration in which the send-for-display thread is in the runnable state reaches T4, the electronic device may migrate the send-for-display thread to another idle core (for example, a core 2), and continue to perform the send-for-display task of the send-for-display thread on the core 2, to avoid long-term blocking of the send-for-display thread.

The foregoing mainly uses a thread in a runnable state as an example for description to reduce a delay of a task of the thread in the runnable state. In some other embodiments, for a thread in a blocked state, a task of the thread may be asynchronously executed. In other words, the task of the thread and a task of another thread may be simultaneously executed, to reduce a delay of the task of the thread and improve processing efficiency of the electronic device.

In some solutions, a plurality of embodiments of this application may be combined, and a combined solution is implemented. Optionally, some operations in the procedures of the method embodiments are randomly combined, and/or a sequence of some operations is randomly changed. In addition, an execution sequence between steps of each process is merely an example, and does not constitute a limitation on the execution sequence between the steps. The steps may alternatively be performed in another execution sequence. It is not intended to indicate that the execution sequence is the only sequence in which these operations can be performed. A person of ordinary skill in the art may learn various manners of rearranging the operations described in this specification. In addition, it should be noted that process details related to an embodiment in this specification are also applicable to another embodiment in a similar manner, or different embodiments may be used in combination.

In addition, some steps in the method embodiments may be equivalently replaced with other possible steps. Alternatively, some steps in the method embodiments may be optional, and may be deleted in some use scenarios. Alternatively, another possible step may be added to the method embodiments.

In addition, the method embodiments may be implemented separately or in combination.

It may be understood that, to implement the foregoing functions, the electronic device in embodiments of this application includes corresponding hardware structures and/or software modules for performing the functions. With reference to the units and algorithm steps in the examples described in embodiments disclosed in this application, embodiments of this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation falls beyond the scope of the technical solutions in embodiments of this application.

In embodiments of this application, the electronic device may be divided into function units based on the foregoing method examples, for example, each function unit may be obtained through division based on each corresponding function, or two or more functions may be integrated into one processing unit. The integrated unit may be implemented in a form of hardware, or may be implemented in a form of a software function unit. It should be noted that, in embodiments of this application, division into units is an example, and is merely logical function division. In actual implementation, another division manner may be used.

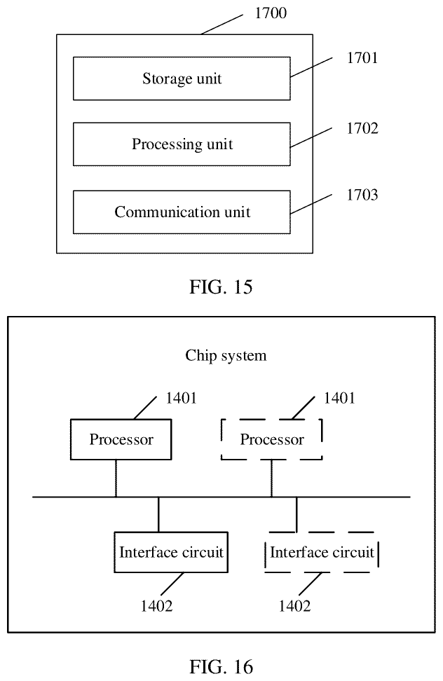

FIG. 15 is a block diagram of a memory management apparatus according to an embodiment of this application. The apparatus may be the foregoing electronic device or a component having a corresponding function. The apparatus 1700 may exist in a form of software, or may be a chip that can be used in a device. The apparatus 1700 includes a processing unit 1702.

The processing unit 1702 may be configured to support S101, S103, S104, and the like shown in FIG. 10, and/or configured to perform another process of the solutions described in this specification.

In some embodiments, the apparatus 1700 may further include a communication unit 1703. Optionally, the communication unit 1703 may be further divided into a sending unit (not shown in FIG. 15) and a receiving unit (not shown in FIG. 15). The sending unit is configured to support the apparatus 1700 in sending information to another electronic device. The receiving unit is configured to support the apparatus 1700 in receiving information from another electronic device.

In some embodiments, the apparatus 1700 may further include a storage unit 1701, configured to store program code and data of the apparatus 1700. The data may include but is not limited to original data, intermediate data, or the like.

In a possible manner, the processing unit 1702 may be a controller or the processor 401 or the processor 408 shown in FIG. 6. For example, the processing unit may be a central processing unit (Central Processing Unit, CPU), a general-purpose processor, a digital signal processor (Digital Signal Processor, DSP), an application-specific integrated circuit (Application-Specific Integrated Circuit, ASIC), a field-programmable gate array (Field-Programmable Gate Array, FPGA) or another programmable logic device, a transistor logic device, a hardware component, or any combination thereof. The processing unit may implement or execute various example logical blocks, modules, and circuits described with reference to content disclosed in this application. The processor may alternatively be a combination for implementing a computing function, for example, a combination including one or more microprocessors, or a combination of a DSP and a microprocessor.

In a possible manner, the communication unit 1703 may include the transceiver 404 shown in FIG. 6, and may further include a transceiver circuit, a radio frequency component, and the like.

In a possible manner, the storage unit 1701 may be the memory 403 shown in FIG. 6.

An embodiment of this application further provides an electronic device, including one or more processors and one or more memories. The one or more memories are coupled to the one or more processors. The one or more memories are configured to store computer program code, and the computer program code includes computer instructions. When the one or more processors execute the computer instructions, the electronic device is enabled to perform the foregoing related method steps, to implement the method in the foregoing embodiments.

An embodiment of this application further provides a chip system. As shown in FIG. 16, the chip system includes at least one processor 1401 and at least one interface circuit 1402. The processor 1401 and the interface circuit 1402 may be connected to each other through a line. For example, the interface circuit 1402 may be configured to receive a signal from another apparatus (for example, a memory in an electronic device). For another example, the interface circuit 1402 may be configured to send a signal to another apparatus (for example, the processor 1401). For example, the interface circuit 1402 may read instructions stored in a memory, and send the instructions to the processor 1401. When the instructions are executed by the processor 1401, the electronic device is enabled to perform the steps in the foregoing embodiments. Certainly, the chip system may further include another discrete device. This is not specifically limited in embodiments of this application.

An embodiment of this application further provides a computer-readable storage medium. The computer-readable storage medium includes computer instructions. When the computer instructions are run on the foregoing electronic device, the electronic device is enabled to perform the functions or steps performed by the mobile phone in the foregoing method embodiments.

An embodiment of this application further provides a computer program product. When the computer program product runs on a computer, the computer is enabled to perform the functions or steps performed by the mobile phone in the foregoing method embodiments.

Based on the foregoing descriptions of the implementations, a person skilled in the art may clearly understand that for the purpose of convenient and brief descriptions, division into the foregoing function modules is merely used as an example for descriptions. In actual application, the foregoing functions can be allocated to different function modules for implementation based on a requirement. In other words, an inner structure of an apparatus is divided into different function modules to implement all or some of the functions described above.

In the several embodiments provided in this application, it should be understood that the disclosed apparatus and method may be implemented in other manners. For example, the described apparatus embodiments are merely examples. For example, division into the modules or units is merely logical function division. In actual implementation, there may be another division manner. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of embodiments.

In addition, function units in embodiments of this application may be integrated into one processing unit, each of the units may exist alone physically, or two or more units may be integrated into one unit. The integrated unit may be implemented in a form of hardware, or may be implemented in a form of a software function unit.

When the integrated unit is implemented in the form of the software function unit and sold or used as an independent product, the integrated unit may be stored in a readable storage medium. Based on such an understanding, the technical solutions of embodiments of this application essentially, or the part contributing to the conventional technology, or all or some of the technical solutions may be implemented in a form of a software product. The software product is stored in a storage medium and includes several instructions for enabling a device (which may be a single-chip microcomputer, a chip, or the like) or a processor (processor) to perform all or some of the steps of the method described in embodiments of this application. The foregoing storage medium includes any medium that can store program code, such as a USB flash drive, a removable hard disk, a read-only memory (ROM), a random access memory (RAM), a magnetic disk, or a compact disc.

The foregoing descriptions are only specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

It should be understood that the steps in the foregoing method embodiments may be completed by using a hardware integrated logic circuit or instructions in a form of software in the processor. The steps of the method disclosed with reference to embodiments of this application may be directly performed by a hardware processor, or may be performed by using a combination of hardware and software modules in the processor.

An embodiment of this application further provides a computer-readable storage medium. The computer-readable storage medium stores computer instructions. When the computer instructions are executed on an electronic device, the electronic device is enabled to perform the foregoing related method steps to implement the method in the foregoing embodiments.

An embodiment of this application further provides a computer program product. When the computer program product runs on a computer, the computer is enabled to perform the foregoing related steps to implement the method in the foregoing embodiments.

In addition, an embodiment of this application further provides an apparatus. The apparatus may be specifically a component or a module. The apparatus may include a processor and a memory that are connected to each other. The memory is configured to store computer-executable instructions. When the apparatus runs, the processor may execute the computer-executable instructions stored in the memory, so that the apparatus performs the method in the foregoing method embodiments.

The electronic device, the computer-readable storage medium, the computer program product, or the chip provided in embodiments of this application is configured to perform the corresponding method provided above. Therefore, for beneficial effects that can be achieved, refer to the beneficial effects in the corresponding method provided above. Details are not described herein again.

It may be understood that, to implement the foregoing functions, the electronic device includes a corresponding hardware and/or software module for performing each function. With reference to algorithm steps in the examples described with reference to embodiments disclosed in this specification, this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application with reference to embodiments, but it should not be considered that the implementation goes beyond the scope of this application.

In embodiments, the electronic device may be divided into function modules based on the foregoing method examples, for example, each function module may be obtained through division based on each corresponding function, or two or more functions may be integrated into one processing module. The integrated module may be implemented in a form of hardware. It should be noted that, in embodiments, division into the modules is an example, is merely logical function division. In actual implementation, another division manner may be used

Based on the foregoing descriptions of the implementations, a person skilled in the art may clearly understand that for the purpose of convenient and brief descriptions, division into the foregoing function modules is merely used as an example for descriptions. In actual application, the foregoing functions can be allocated to different function modules for implementation based on a requirement. An inner structure of the apparatus is divided into different function modules to implement all or some of the functions described above. For a detailed working process of the foregoing system, apparatus, and unit, refer to a corresponding process in the foregoing method embodiments. Details are not described herein again.

In the several embodiments provided in this application, it should be understood that the disclosed method may be implemented in other manners. For example, the described terminal device embodiments are merely examples. For example, division into the modules or units is merely logical function division. In actual implementation, there may be another division manner. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the modules or units may be implemented in electronic, mechanical, or other forms.

The units described as separate parts may or may not be physically separate, and parts displayed as units may or may not be physical units, may be located in one place, or may be distributed on a plurality of network units. Some or all of the units may be selected based on actual requirements to achieve the objectives of the solutions of embodiments.

In addition, function units in embodiments of this application may be integrated into one processing unit, each of the units may exist alone physically, or two or more units may be integrated into one unit. The integrated unit may be implemented in a form of hardware, or may be implemented in a form of a software function unit.

When the integrated unit is implemented in the form of the software function unit and sold or used as an independent product, the integrated unit may be stored in a computer-readable storage medium. Based on such an understanding, the technical solutions of this application essentially, or the part contributing to the conventional technology, or all or some of the technical solutions may be implemented in a form of a software product. The computer software product is stored in a storage medium and includes several instructions for enabling a computer device (which may be a personal computer, a server, or a network device) or a processor to perform all or some of the steps of the method described in embodiments of this application. The foregoing storage medium includes any medium that can store program instructions such as a flash memory, a removable hard disk, a read-only memory, a random access memory, a magnetic disk, or an optical disc.

The foregoing descriptions are only specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A method, applied to an electronic device, and the method comprising:
receiving a first operation;
detecting that a first thread is in a runnable state on a first processing unit, and a second thread runs on the first processing unit, wherein the first thread comprises a composition thread or a send-for-display thread, and a priority of the first thread is lower than a priority of the second thread; and
migrating, a first task of the first thread to a second processing unit, so that the first thread executes, on the second processing unit, the first task associated with the first operation, wherein the first task comprises a layer composition task or a send-for-display task.

2. The method according to claim 1, wherein migrating, by the electronic device, the first task of the first thread to the second processing unit comprises:
when a duration in which the first thread is in the runnable state exceeds a threshold, migrating, by the electronic device, the first task of the first thread to the second processing unit.

3. The method according to claim 1, wherein a third thread runs on the second processing unit, a priority of the third thread is lower than the priority of the first thread, and that the first thread executes, on the second processing unit, the first task associated with the first operation comprises: preempting, by the first thread, the second processing unit and executing the first task on the second processing unit.

4. The method according to claim 1, wherein the first operation comprises an operation of starting a first application, and the first task is a layer composition task;
wherein that the first thread executes, on the second processing unit, the first task associated with the first operation comprises: composing, by the first thread, a startup animation effect of the first application on the second processing unit; and
wherein the method further comprises: displaying the startup animation effect on a display.

5. The method according to claim 1, wherein the first operation comprises an operation of starting a first application, and the first task is a send-for-display task;
wherein that the first thread executes, on the second processing unit, the first task associated with the first operation comprises: transmitting, by the first thread on the second processing unit, a startup animation effect of the first application to a display; and
wherein the method further comprises: displaying the startup animation effect on the display.

6. The method according to claim 1, wherein the first operation comprises an operation of ending a first application, and the first task is a layer composition task;
wherein that the first thread executes, on the second processing unit, the first task associated with the first operation comprises: composing, by the first thread, an end animation effect of the first application on the second processing unit; and
wherein the method further comprises: displaying the end animation effect on a display.

7. The method according to claim 1, wherein the first operation comprises an operation of ending a first application, and the first task is a send-for-display task;
wherein that the first thread executes, on the second processing unit, the first task associated with the first operation comprises: transmitting, by the first thread on the second processing unit, an end animation effect of the first application to a display; and
wherein the method further comprises: displaying the end animation effect on the display.

8. The method according to claim 1, wherein a preset field of the first thread is set to a preset value.

9. An electronic device, comprising:
at least one processor and at least one memory, wherein the at least one memory is coupled to the at least one processor, the at least one memory stores computer program code, the computer program code comprises computer instructions, and when the at least one processor reads the computer instructions from the at least one memory, the electronic device is enabled to:
receive a first operation;
when a first thread of the electronic device is in a runnable state on a first processing unit, and a second thread of the electronic device runs on the first processing unit, migrate a first task of the first thread to a second processing unit, wherein the first thread comprises a composition thread or a send-for-display thread, and a priority of the first thread is lower than a priority of the second thread; and
execute, by the first thread on the second processing unit, the first task associated with the first operation, wherein the first task comprises a layer composition task or a send-for-display task.

10. The electronic device according to claim 9, wherein when the at least one processor reads the computer instructions from the at least one memory, the electronic device is enabled to:
when a duration in which the first thread is in the runnable state exceeds a threshold, migrate the first task of the first thread to the second processing unit.

11. The electronic device according to claim 9, wherein a third thread of the electronic device runs on the second processing unit, a priority of the third thread is lower than the priority of the first thread, and
wherein when the at least one processor reads the computer instructions from the at least one memory, the electronic device is enabled to:
preempt, by the first thread, the second processing unit, and execute the first task on the second processing unit.

12. The electronic device according to claim 9, wherein the first operation comprises an operation of starting a first application, and the first task is a layer composition task;
wherein when the at least one processor reads the computer instructions from the at least one memory, the electronic device is enabled to:
compose, by the first thread, a startup animation effect of the first application on the second processing unit; and
display the startup animation effect on a display.

13. The electronic device according to claim 9, wherein the first operation comprises an operation of starting a first application, and the first task is a send-for-display task;
wherein when the at least one processor reads the computer instructions from the at least one memory, the electronic device is enabled to:
transmit, by the first thread on the second processing unit, a startup animation effect of the first application to a display; and
display the startup animation effect on the display.

14. The electronic device according to claim 9, wherein the first operation comprises an operation of ending a first application, and the first task is a layer composition task;
wherein when the at least one processor reads the computer instructions from the at least one memory, the electronic device is enabled to:
compose, by the first thread of the electronic device, an end animation effect of the first application on the second processing unit; and
display the end animation effect on a display.

15. The electronic device according to claim 9, wherein the first operation comprises an operation of ending a first application, and the first task is a send-for-display task;
wherein when the at least one processor reads the computer instructions from the at least one memory, the electronic device is enabled to:
transmit, by the first thread on the second processing unit, an end animation effect of the first application to a display; and
display the end animation effect on the display.

16. The electronic device according to claim 9, wherein a preset field of the first thread is set to a preset value.

17. A non-transitory computer-readable storage medium, comprising computer instructions, wherein when the computer instructions are run on an electronic device, the electronic device is enabled to:
receive a first operation;
when a first thread of the electronic device is in a runnable state on a first processing unit, and a second thread of the electronic device runs on the first processing unit, migrate a first task of the first thread to a second processing unit, wherein the first thread comprises a composition thread or a send-for-display thread, and a priority of the first thread is lower than a priority of the second thread; and
execute, by the first thread on the second processing unit, the first task associated with the first operation, wherein the first task comprises a layer composition task or a send-for-display task.

18. The non-transitory computer-readable storage medium according to claim 17, wherein when the computer instructions are run on the electronic device, the electronic device is enabled to:
when a duration in which the first thread is in the runnable state exceeds a threshold, migrate the first task of the first thread to the second processing unit.

19. The computer-readable storage medium according to claim 17, wherein a third thread of the electronic device runs on the second processing unit, a priority of the third thread is lower than the priority of the first thread, and
when the computer instructions are run on the electronic device, the electronic device is enabled to:
preempt, by the first thread, the second processing unit, and execute the first task on the second processing unit.

20. The computer-readable storage medium according to claim 17, wherein the first operation comprises an operation of starting a first application, and the first task is a layer composition task;
when the computer instructions are run on the electronic device, the electronic device is enabled to:
compose, by the first thread, a startup animation effect of the first application on the second processing unit; and
display the startup animation effect on a display.
